(19) United States
(12) Patent Application Publication
(10) Pub. No.: US 2008/0028582 A1
(43) Pub. Date: Feb. 7, 2008

(54) Fur and Fur Lace Made of Artificial or Natural Fur and the Product Method Thereof

(76) Inventors: Jae-Kyun Lee, Gimpo-si (KR); Jae-Yeu Lee, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 11/630,798

(22) PCT Filed: Apr. 12, 2005
(86) PCT No.: PCT/KR05/01047

§ 371 Date: Jan. 26, 2007

(30) Foreign Application Priority Data
Jul. 8, 2004 (KR) 10-2004-0053026

(51) Int. Cl. D06C 23/00; C14B 1/00

(52) U.S. Cl. 28/160; 28/159; 69/22

(57) ABSTRACT

A fur lace made of two or more artificial or natural fur pieces with pile fibers projected in a direction, a method for manufacturing a fur product, and a fur lace and a fur product manufactured by the method are disclosed. The leather portions of side fur pieces sewn at both sides of a center fur piece are utilized as a margin to sew up, rather than a bias tape for sewing a fur lace to a cloth or a general product, to thereby simplify manufacturing procedures and achieve aesthetic enhancement by changing direction of pile fibers and increasing the density of pile fibers of a specific part. When the fur lace is sewn on a cloth, bag, or other products, cut portions and seam line of a fur are completely covered by pile fibers or exposed to achieve aesthetic enhancement. In addition, pile fibers around the root of hair can be prevented from being curled up into a needle and thread, thereby improving productivity by eliminating the necessity of plucking out the pile fibers entangled with the thread by using a comb or an awl after completion of sewing work. The fur lace can be sewn to a wide variety of products including a cloth, bag, shoes, hat, shawl, muffler, and other accessories. The fur lace can be made from an artificial or natural fur.

### TECHNICAL FIELD

The present invention relates to a fur lace made of two or more artificial or natural fur pieces with pile fibers projected in a direction, a method for manufacturing a fur product, and a fur lace and a fur product manufactured by the method. More particularly, the present invention relates to a fur lace made of artificial or natural fur pieces, in which a margin required for sewing a lace on a textile is ensured by sewing up side fur pieces which are obtained by inversing pile fibers and leather in an opposite direction to both sides of a center fur piece, and a method for manufacturing a fur product, and a fur lace and a fur product manufactured by the method. The fur lace of the present invention prevents pile fibers from being curled up into a needle or a thread when the lace is sewn onto a textile. The fur lace of the present invention can be put on a textile and sewn even without cutting the textile.

### BACKGROUND ART

In general, natural fur has properties in that pile fibers are projected in a direction from a head to a tail or from a back center to a belly. An artificial fur can be manufactured such that pile fibers are projected in a direction. When a natural fur is cut to be used, the leather portion at the opposite side from pile fibers is exposed as it is. In case of dyeing a natural fur, differences of light and dark color tones exist between longer pile fibers (outer pile fibers) and shorter pile fibers (inner pile fibers) of the natural fur. An artificial fur is provided with such differences of light and dark color tones for the purpose of making the artificial fur similar to a natural fur.

### DISCLOSURE OF INVENTION

### Technical Problem

The inner pile fibers around the root of hair of a natural fur are thinner and more soft as compared with the outer pile fibers, but easily entangled by a friction and so on.

In case of manufacturing a fur lace to be sewn on a textile, from a natural or artificial fur, a foreign substance including a bias tape needs to be attached to the lace so as to prevent exposure of the cut leather side and ensure a margin to sew up.

However, such a foreign substance attached to the fur lace reduces softness of a fur and causes an aesthetic deterioration since a bias tape is exposed. In case where a fur lace is disposed on a textile and sewn without using an auxiliary tape like a bias tape, pile fibers around the root of hair are curled up into a thread. This requires labor of plucking out the pile fibers entangled with the thread by using an awl after completion of sewing work.

In a conventional method where furs with same or different properties or colors are attached, pile fibers of a center fur piece and a side fur piece irregularly push each other, thus making spacings between pile fibers at the center fur piece irregularly narrow. When thus-made fur lace is sewn on a textile, an auxiliary tape is needed. Moreover, effectiveness of properties or colors of a fur might be reduced, and it is difficult to make the best use of characteristics of inner pile fibers of the fur.

### Technical Solution

It is an object of the present invention to provide a fur lace, a method for manufacturing a fur product using the same, and a fur lace and a fur product manufactured by the same method, in which leather portions of side fur pieces sewn at both sides of a center fur piece are utilized as a margin to sew up, rather than a bias tape for sewing a fur lace to a cloth or a general product, to thereby simplify manufacturing procedures and achieve aesthetic enhancement by changing direction of pile fibers and increasing the density of pile fibers of a specific part.

When the fur lace of the present invention is sewn on a cloth, bag, or other products, cut portions and seam line of a fur are completely covered by pile fibers or exposed to achieve aesthetic enhancement. In addition, pile fibers around the root of hair can be prevented from being curled up into a needle and thread, thereby improving productivity by eliminating the necessity of plucking out the pile fibers entangled with the thread by using a comb or an awl after completion of sewing work. The fur lace of the present invention can be sewn on a wide variety of products including a cloth, bag, shoes, hat, shawl, muffler, and other accessories. The fur lace can be made from an artificial or natural fur.

### ADVANTAGEOUS EFFECTS

In the present invention, the leather portion of the side furs which are turned upside down and sewn on both sides of the center fur is used as a margin to sew up, work procedures are simplified, and pile fiber density at a specific part is increased. This makes it possible to make the best use of properties of the fur, and achieve aesthetic enhancement. The fur lace of the present invention can be utilized in a wide variety of products including clothes, bags, shoes, hats, shawls, mufflers, and other accessories.

### BRIEF DESCRIPTION OF THE DRAWINGS

FIG. 1 is a plane view illustrating a fur lace made by connecting an artificial or natural fur according to the present invention;

FIG. 2 illustrates processes of manufacture of a fur lace and a fur product according to the present invention;

FIG. 3 is a vertical cross section illustrating fur laces sewn on a textile according to the present invention; and

FIG. 4 is a plane view illustrating fur laces sewn on a textile according to the present invention.

### BEST MODE FOR CARRYING OUT THE INVENTION

A fur lace, a method for manufacturing a fur product, and a fur lace and a fur product manufactured by the method will be explained in detail with reference to the attached drawings. In drawings, identical elements or components bear identical reference numerals. Throughout the specification, detailed descriptions of related known art or configuration will be omitted to avoid ambiguity of the features of the present invention.

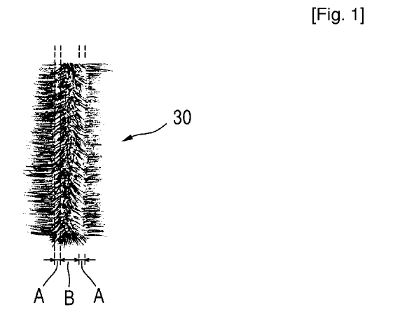

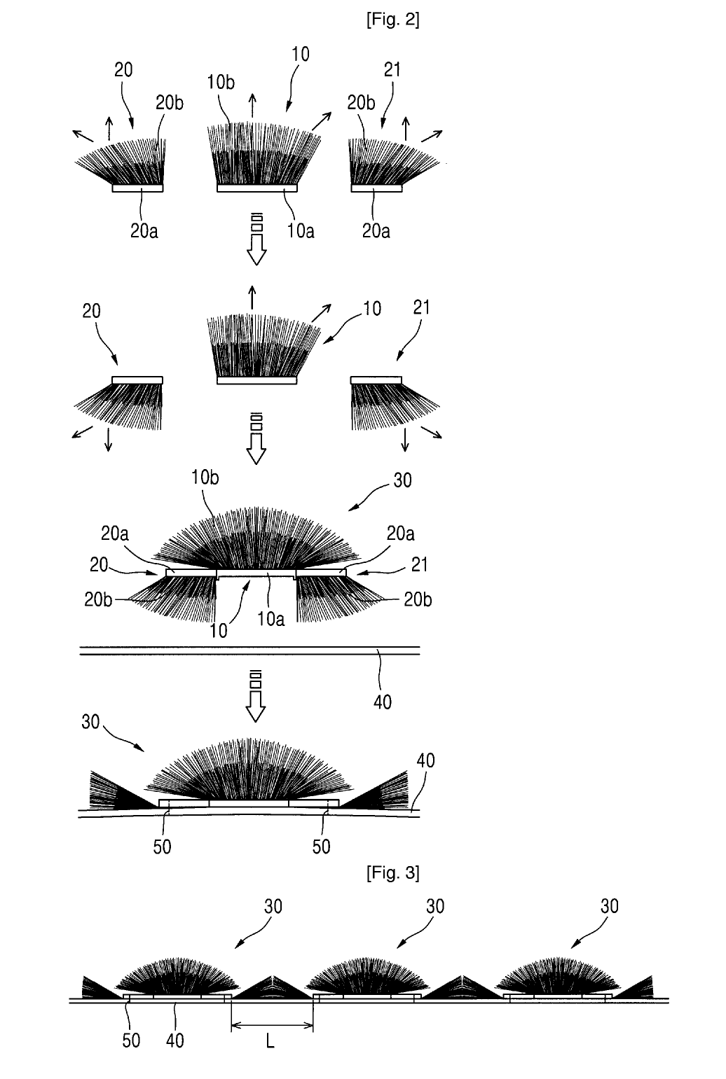

FIG. 1 is a plane view illustrating a fur lace made by connecting an artificial or natural fur according to the present invention, and FIG. 2 illustrates processes of manufacture of a fur lace and a fur product according to the present invention. As shown in FIGS. 1 and 2, a piece of a center fur 10 is disposed, wherein the center fur has a leather 10a on which pile fibers 10b are projected in upward and lengthwise directions. Two pieces of side furs 20 and 21 are disposed at both sides of the center fur. The side furs have properties and colors different from those of the center fur. Each of the side furs has a leather 20a on which pile fibers 20b are projected in an upward direction and outwardly in a widthwise direction. The side furs are turned upside down such that the pile fibers 20b are directed downward.

In cases where the center fur and the side furs are made into an artificial fur, the leather described above can be replaced by a cloth, and the center fur and the side furs can be made from the same material. Since one of the center fur and the side furs is utilized as being turned upside down, the center fur and the side furs can be regarded as materials with different properties or colors.

An end of one side of the leather 10a of the center fur 10 and an end of one side of the leather 20a of one of the side furs are superimposed with each other, and the superimposed portion is sewn up. The resultant side fur 20 is spread outward. An end of the other side of the leather 10 and an end of one side of the leather 20a of the other of the side furs are superimposed with each other, and the superimposed portion is sewn up. The resultant side fur 21 is spread.

As a result, pile fibers on the leather of the center fur are directed upward, while the pile fibers on the leather of each of the side furs sewn up to both sides of the center fur are directed downward. The pile fibers of the side furs are projected in an opposite direction. The center fur and the side furs with different properties and colors are sewn up into a fur lace 30 shown in FIG. 1, where A denotes the quantity of leather of pile fibers of side furs and B denotes the quantity of leather of pile fibers of center fur.

At the state where the thus-obtained fur lace 30 is disposed on a textile 40 and pile fibers 20b of side furs 20 and 21 sewn up at both sides of the center fur 10 are pressed by the textile so as to be projected outward, a sewing process is performed in a lengthwise direction on the leathers 20a of the side furs so as to sew up the fur lace 30 on the textile 40. In this manner, interferences between pile fibers of the center fur and pile fibers of the side furs can be prevented in the process of sewing up the fur lace on the textile.

Accordingly, pile fibers of the center fur with properties and colors different from those of the pile fibers of the side furs, may not be pushed or shrunk by the pile fibers of the side furs. Moreover, pile fibers of the side furs are projected outward, in a high density of pile fibers regardless of the pile fibers of the center fur. This makes it possible to clearly distinguish pile fibers of different properties and colors on a fur lace. A seaming line 50 formed by sewing up the leather of the side furs on the textile can be hidden by the pile fibers of the center fur.

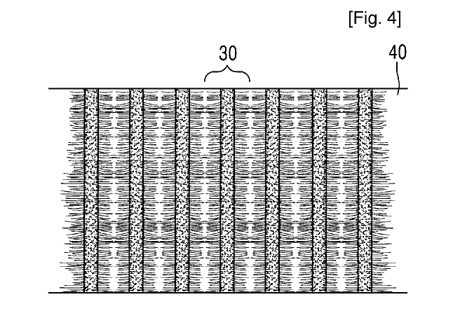

FIG. 3 is a vertical cross section illustrating fur laces sewn on a textile according to the present invention, and FIG. 4 is a plane view illustrating fur laces sewn on a textile according to the present invention. As shown in FIGS. 3 and 4, the fur laces 30 are sequentially arranged in parallel with each other on the textile 40, and sewn up on the textile 40 in such a manner that the pile fibers 20a projected outward in a widthwise direction, from the side furs 20 and 21 by predetermined lengths are not superimposed with each other. In this manner, less amount of furs can be sewn up all over the textile.

The fur lace of the present invention can be sewn up on the textile according to the method of the present invention. The textile is then cut into a wide variety of shapes so as to produce fur clothes, fur bags, fur shoes, fur hats, fur mufflers, and other fur accessories. It is also possible to make the above-mentioned fur products by using the textile on which the fur lace of the present invention has already been sewn up.

Although the invention has been described by reference to specific embodiments, it should be understood that numerous changes may be made within the spirit and scope of the inventive concepts described.

### MODE FOR THE INVENTION

To accomplish the object of the present invention, there is provided a method for manufacturing a fur lace, including a step of preparing one piece of a center fur with pile fibers projected in a lengthwise direction on a surface of an artificial or natural leather, and two pieces of side furs with pile fibers projected in a widthwise direction on a surface of an artificial or natural leather; a step of turning upside down a leather side of one piece of the side furs, permitting the one piece of the center fur and the turned leather side of one piece of the side furs to face each other, and sewing up the faced widthwise ends of each of the center fur and the side fur, and spreading the side fur in such a manner that pile fibers of the center fur and the side fur are directed in a vertically opposite direction and pile fibers of the side fur are projected outward from one side of the center fur; and a step of turning upside down a leather side of the other piece of the side furs, permitting the one piece of the center fur and the turned leather side of the other piece of the side furs to face each other, and sewing up the faced widthwise ends of each of the center fur and the side fur, and spreading the side fur in such a manner that pile fibers of the center fur and the side fur are directed in a vertically opposite direction and pile fibers of the side fur are projected outward from the other side of the center fur.

There is provided a method for manufacturing a fur product, including a step of disposing a fur lace on a textile; and a step of sewing the fur lace on leather sides of side furs at both sides of a center fur, in such a manner that pile fibers of the center fur are directed upward and pile fibers of the side furs are pressed between the textile and the leather sides of the side furs, and the pile fibers are projected outward from both sides of the center fur.

The textile on which the fur lace is sewn, is utilized in manufacture of fur clothes, fur hat, fur muffler, fur bag, and fur shoes and the like.

The center fur and the side furs are different types of furs having different properties or colors.

The fur lace of the present invention is characterized in that pile fibers of the center fur are projected upward in a lengthwise direction, and pile fibers of the respective side furs inversely sewn up to both sides of the center fur are projected downward in a widthwise direction.

The fur lace of the present invention is characterized in that pile fibers of the center fur are projected upward in a lengthwise direction on a textile, pile fibers of the respective side furs inversely sewn up to both sides of the center fur are projected downward in a widthwise direction, part of the pile fibers is pressed by the textile, and the pile fibers are projected outwardly from both sides of the center fur.

### INDUSTRIAL APPLICABILITY

The fur lace, the method for manufacturing a fur product using the fur lace, and the fur lace and the fur product manufactured by the method of the present invention have advantages as follows.

First, the inversed portion of the leather of the side fur can serve as a margin to sew up, the necessity of using a bias tape is eliminated.

Second, pile fibers are prevented from being curled up into a thread, to thereby eliminate unnecessary processes.

Third, since the direction of pile fibers of side furs can be changes, the widest fur area can be exposed without increasing the quantity of the fur.

Fourth, since two or more materials are sewn up with each other, by being turned upside down, properties of both the outer pile fibers and inner pile fibers are exhibited.

Fifth, width of a fur can be adjusted when the fur is cut, such that a leather portion is completely hidden or exposed, and harmony of stitches can be obtained.

Sixth, the fur lace of the present invention an be utilized on any type of textile (fabric or leather), in the form of the fur lace as it is, or in the form of the fur lace sewn on the textile.

Seventh, fur products with a wide variety of designs can be made through a general process for manufacture of clothes.

Eighth, fur products made from the fur lace of the present invention or the textile with the fur lace may have improved softness.

Ninth, the fur lace of the present invention is light weight and provided with improved flexibility.

Tenth, the fur lace of the present invention is provided with improved resistance against tear.

Eleventh, costs for manufacture of textile or clothes can be reduced since less amount of fur is used.

Twelfth, it is possible to make the best use of the properties of fur, since inner pile fibers around the root of hair are exposed.

1. A method for manufacturing a fur lace from an artificial or natural fur, comprising:
a step of preparing one piece of a center fur with pile fibers projected in a lengthwise direction on a surface of an artificial or natural leather, and two pieces of side furs with pile fibers projected in a widthwise direction on a surface of an artificial or natural leather;
a step of turning upside down a leather side of one piece of said side furs, permitting said one piece of the center fur and the turned leather side of one piece of said side furs to face each other, and sewing up the faced widthwise ends of each of the center fur and the side fur, and spreading said side fur in such a manner that pile fibers of said center fur and said side fur are directed in a vertically opposite direction and pile fibers of the side fur are projected outward from one side of said center fur; and
a step of turning upside down a leather side of the other piece of said side furs, permitting said one piece of the center fur and the turned leather side of the other piece of said side furs to face each other, and sewing up the faced widthwise ends of each of the center fur and the side fur, and spreading said side fur in such a manner that pile fibers of said center fur and said side fur are directed in a vertically opposite direction and pile fibers of the side fur are projected outward from the other side of said center fur.

2. A method according to claim 1, wherein said center fur and said side furs are different types of furs with different colors.

3. A method for manufacturing a fur product by using a fur lace made from an artificial or natural fur, comprising:
a step of disposing the fur lace manufactured by the method of claim 1, on a textile; and
a step of sewing said fur lace on leather sides of side furs at both sides of a center fur, in such a manner that pile fibers of the center fur are directed upward and pile fibers of the side furs are pressed between the textile and the leather sides of the side furs, and the pile fibers are projected outward from both sides of said center fur.

4. A method according to claim 3, wherein a textile on which said fur lace is sewn, is utilized in manufacture of fur clothes, fur hats, fur mufflers, fur bags, fur shoes, and fur accessories.

5. A method according to claim 3, wherein said center fur and said side furs are different types of furs having different properties or colors.

6. A fur lace made from an artificial or natural fur by the method of claim 1, having pile fibers of a center fur being projected upward in a lengthwise direction and pile fibers of side furs inversely sewn up to both sides of said center fur being projected downward in a widthwise direction.

7. A fur product using a fur lace made from an artificial or natural fur by the method of claim 3, wherein pile fibers of a center fur of said fur lace are projected upward in a lengthwise direction on a textile, pile fibers of side furs of said fur lace inversely sewn up to both sides of said center fur are projected downward in a widthwise direction, part of said pile fibers is pressed by said textile, and the pile fibers are projected outwardly from both sides of said center fur.
